(19) United States
(12) Patent Application Publication
(10) Pub. No.: US 2009/0272819 A1
(43) Pub. Date: Nov. 5, 2009

(54) Disposable liquid paint reservoir with internal support member for use with paint spray guns

(75) Inventors: Mark E. Charpie, Ottawa Lake, MI (US); Michael Kosmyna, Toledo, OH (US); Thomas R. White, Maumee, OH (US)

Correspondence Address: Steven W. Weinrieb;LAW OFFICES OF STEVEN W. WEINRIEB, 8717 Cold Spring Road, Potomac, MD, 20854, US

(73) Assignee: ILLINOIS TOOL WORKS INC.

(21) Appl. No.: 12/149,322

(22) Filed: Apr. 30, 2008

(51) Int. Cl. B05B 15/00; B65D 33/36

(52) U.S. Cl. 239/327; 383/33

(57) ABSTRACT

A liquid paint reservoir, which is adapted to be mounted atop a paint spray gun, has an adaptor or head portion sealingly mounted within an opening of the reservoir, and a substantially rigid support member extends internally within the liquid paint reservoir so as to effectively prevent the liquid paint reservoir from flopping or folding over upon itself during a paint spraying operation which could operatively interfere with the dispensing of the paint, or which could prevent the complete evacuation of the liquid paint from the liquid paint reservoir, or which could adversely alter the desired control of the paint spray gun by the operator personnel so as to, in turn, adversely affect the preciseness and finish appearance of the paint being sprayed onto a particular substrate.

### FIELD OF THE INVENTION

The present invention relates generally to liquid applicators, such as, for example, paint spray guns, and more particularly to a new and improved paint spray gun which has a liquid paint reservoir fixedly attached, for example, to an upper portion of the gun so as to permit the liquid paint to be gravity fed into a paint discharge path formed within the spray gun, and from which the liquid paint is dispensed outwardly from the paint spray gun by compressed air that is also discharged from the paint spray gun within the nozzle region of the paint spray gun. A substantially rigid support member is provided upon an adaptor member or head portion sealingly mounted within an opening of the liquid paint reservoir, wherein the adaptor member or head portion operatively serves to fluidically connect the liquid paint reservoir to the paint spray gun, and wherein the substantially rigid support member extends internally within the liquid paint reservoir, and along a substantial portion of a major dimension or axis of the liquid paint reservoir, as defined from the adaptor member to an opposite end or corner portion of the liquid paint reservoir, so as to effectively prevent the liquid paint reservoir from flopping or folding over upon itself during a paint spraying operation which could operatively interfere with the dispensing of the paint, which could prevent the complete evacuation of the liquid paint from the liquid paint reservoir, or which could adversely alter the desired control of the paint spray gun by the operator personnel so as to, in turn, adversely affect the preciseness and finish appearance of the paint being sprayed onto a particular substrate.

### BACKGROUND OF THE INVENTION

Paint spray guns are widely used, for example, in the automotive industry, and particularly within automotive body repair shops in connection with, for example, the repainting of vehicles subsequent to their repair following an accident. The paint is usually disposed within a suitable reservoir or container which is adapted to be fixedly attached to the paint spray gun, and in accordance with one type of conventional reservoir or container, the container or reservoir comprises a rigid pot or receptacle having a removable lid or cover for permitting the pot or receptacle to be filled with the particular paint to be applied to the substrate. It has been appreciated, however, that upon completion of a particular spray-painting operation, if there is any paint remaining within the pot or receptacle, it would normally be removed and properly stored for subsequent use, or alternatively, if the entire supply of paint originally disposed within the pot or receptacle has been used and exhausted, the pot or receptacle must necessarily be cleaned in order to permit the reuse of the same in connection with the supply or dispensing of, for example, a different type of paint, primer, base coat, clear coat, or the like, so as to obviously prevent any cross-contamination between the various different liquids which would adversely affect the achievement of the particularly desired paint color, finish, and the like. Such cleaning operations, however, are necessarily time-consuming and costly in view of the fact that special solvents are required and that operators or maintenance personnel are required to perform the cleaning operations. In addition, once the solvents have been used to clean the pots or receptacles, the disposal of such used solvents is likewise costly.

Accordingly, as disclosed within patent publication WO98325329, which was published on Jul. 30, 1998 in the name of Stephen Joseph et al., apparatus for spraying liquids, such as, for example, paint, was developed wherein, for example, the paint supply pot or receptacle was provided with a removable and disposable liner and lid thereby effectively eliminating the need for any cleaning operations to be performed upon the paint supply pot or receptacle subsequent to the completion of a paint-spraying operation. During the paint spraying operation, the liner effectively collapses as the liquid paint is withdrawn from the pot or receptacle, and more particularly, from the liner, however, it was anticipated or realized that the liner could potentially collapse in a substantially random, uncontrolled manner, thereby effectively forming pockets or recesses within which unused supplies of the liquid paint could potentially become trapped. When the supposedly spent or exhausted liner would then be discarded, such an occurrence would result in the waste of viable paint supplies which would obviously comprise economic disadvantages. Accordingly, still further, the system disclosed within U.S. Pat. No. 6,942,126, which issued to Douglas et al. on Sep. 13, 2005, was developed wherein the paint container, pot, receptacle, or the like is provided with a diaphragm member which gradually conforms to the internal surface contour of the body forming the container, pot, receptacle, or the like, in order to effectively eliminate or prevent the formation of any pockets or recesses within which the paint can become trapped.

While the aforenoted patent publications disclose their respective improvements within the paint-spraying art or industry, it is nevertheless still noted that both systems or apparatus employ substantially rigid pot or receptacle structures for containing their respective liners. Accordingly, such substantially rigid pot or receptacle structures present other operational or economical problems or disadvantages. For example, since the pot or receptacle structures are substantially rigid and not collapsible, they require a substantial amount of storage space. In a similar manner, when they are in fact to be disposed of after, for example, being used a predetermined number of times in conjunction with the performance of a predetermined number of spray painting operations, they likewise occupy a substantial amount of space within suitable waste containers. It has therefore been proposed that, in lieu of such substantially rigid pot or receptacle structures, a disposable and flexible liquid paint reservoir, which may take the form, for example, of a liquid paint container, bag, package, pouch, sack, or the like, which can be disposed in a relatively flattened or collapsed state when not filled with paint, be utilized, however, it has been further appreciated that such structure likewise exhibits an operational drawback. More particularly, due to the inherent flexibility of such liquid paint reservoir, as a result of being fabricated from a suitably flexible yet impervious material, the liquid paint reservoir has the tendency to flop or fold over upon itself as a result of the reciprocal or directionally reversible horizontal or vertical movements of the paint spray gun inherently performed or executed during a typical paint spraying operation. Such flopping or folding over of the liquid paint reservoir could therefore either interfere with or obstruct the withdrawal of the liquid paint from the liquid paint reservoir during the spray painting procedure, or alternatively, could entrap a portion of the paint supply within the liquid paint reservoir which may then be inadvertently discarded and wasted. Still further, such undesired movement of the liquid paint reservoir could adversely alter the desired control of the paint spray gun by means of the operator personnel which would, in turn, adversely affect the preciseness and finish appearance of the paint being sprayed onto a particular substrate.

A need therefore exists in the art for a new and improved disposable liquid paint reservoir which is flexible and collapsible so as to be rendered substantially compact for storage purposes, and yet has sufficient structural integrity inherently or integrally incorporated therein so as to effectively prevent the disposable liquid paint reservoir from flopping or folding over upon itself during the reciprocal or directionally reversible horizontal or vertical movements of the paint spray gun inherently performed or executed during a paint spraying operation so as to effectively pre-vent the aforenoted drawbacks characteristic of conventional liquid paint reservoirs.

### SUMMARY OF THE INVENTION

The foregoing and other objectives are achieved in accordance with the teachings and principles of the present invention through the provision of a new and improved disposable liquid paint reservoir, which is adapted for use in connection with a paint spray gun, which may comprise, for example, a suitable container, bag, package, pouch, sack, or the like, and which is fabricated from a suitable flexible and impervious material, such as, for example, a metal foil or a polyethylene film. An adaptor member or head portion is sealed upon a portion of the liquid paint reservoir so as to effectively define an opening within the noted portion of the liquid paint reservoir which serves as a means to fill the liquid paint reservoir with a desired supply of liquid paint and which also serves as a means by which the liquid paint can be withdrawn from the liquid paint reservoir during operation of the paint spray gun. In addition, a substantially rigid support member is operatively connected to the head portion or adaptor member such that the support member extends internally within the liquid paint reservoir, and along a substantial portion of a major axis or dimension of the liquid paint reservoir, as defined from the adaptor member or head portion to an opposite end portion of the liquid paint reservoir, so as to effectively prevent the liquid paint reservoir from flopping or folding over upon itself during a paint spraying operation which could operatively interfere with the proper dispensing of the paint, which could entrap a portion of the paint supply within the liquid paint reservoir which may then be inadvertently discarded and wasted, or which could adversely alter the desired control of the paint spray gun by the operator personnel so as to, in turn, adversely affect the preciseness and finish appearance of the paint being sprayed onto a particular substrate.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a perspective view of a new and improved liquid paint reservoir, as constructed in accordance with the principles and teachings of the present invention, and illustrating the same prior to the filling of the liquid paint reservoir with a supply of liquid paint through the open mouth portion of the neck portion of an adaptor member of the liquid paint reservoir;

FIG. 2 is a perspective view of the new and improved liquid paint reservoir as illustrated within FIG. 1 and having a funnel operatively associated with the adaptor member of the liquid paint reservoir so as to facilitate the filling of the liquid paint reservoir with a supply of liquid paint to be contained within the liquid paint reservoir and to be ultimately withdrawn from the liquid paint reservoir during a paint spraying operation;

FIG. 3 is a perspective view of the new and improved liquid paint reservoir as illustrated within FIGS. 1 and 2 wherein a first embodiment of a new and improved support structure, which comprises a head member and a stem member integrally connected to the head member, is being inserted through the open mouth region of the neck portion of the adaptor member of the liquid paint reservoir and into the liquid paint reservoir;

FIG. 4 is a perspective view of the new and improved liquid paint reservoir, similar to that illustrated within FIG. 3 wherein the first embodiment of the new and improved support structure has now been fully installed within the open mouth region of the adaptor member of the liquid paint reservoir;

FIG. 5 is a perspective view of the new and improved liquid paint reservoir, similar to that illustrated within FIG. 4 but from the opposite side of the liquid paint reservoir, wherein a coupling member has been fixedly mounted upon the outer peripheral surface portion of the neck portion of the adaptor member of the liquid paint reservoir so as to facilitate the attachment of the new and improved liquid paint reservoir to a paint spray gun;

FIG. 6 is a perspective view of the new and improved liquid paint reservoir, similar to that illustrated within FIG. 5 but from the opposite side of the liquid paint reservoir, wherein an insert plug has been snap-fitted, press-fitted, friction fitted, or the like, into the coupling member so as to permit the liquid paint reservoir to be shaken or used for storage purposes, if desired or necessary, without incurring any inadvertent or accidental discharge of the paint contents, disposed within the liquid paint reservoir, out from the liquid paint reservoir;

FIG. 7 is a perspective view of the new and improved liquid paint reservoir, similar to that illustrated within FIG. 5, but from the opposite side of the liquid paint reservoir, wherein the liquid paint reservoir is being fixedly secured upon a paint spray gun as a result of the coupling member being mated with the paint spray gun by means of, for example, a bayonet-type coupling connection;

FIG. 8 is a side elevational view illustrating the new and improved liquid paint reservoir as being fully mounted upon a paint spray gun in its operative position and orientation;

FIG. 9 is a front elevational view of a second embodiment of a new and improved support structure wherein the stem member, which has a substantially X-shaped or cross-shaped cross-sectional configuration, is integrally formed with the adaptor member of the liquid paint reservoir;

FIG. 10 is a cross-sectional view of the second embodiment of the new and improved support structure as disclosed within FIG. 9 and as taken along the lines 10-10 of FIG. 9;

FIG. 11 is a rear elevational view of the second embodiment of the new and improved support structure as illustrated within FIGS. 9 and 10;

FIG. 12 is a schematic cross-sectional view of the second embodiment support structure, as illustrated within FIGS. 9-11, as mounted within or upon a corner portion of the liquid paint reservoir; and

FIG. 13 is a schematic cross-sectional view of the second embodiment support structure, as illustrated within FIGS. 9-11, as mounted within or upon a side edge portion of the liquid paint reservoir.

### DETAILED DESCRIPTION OF THE ILLUSTRATED EMBODIMENTS

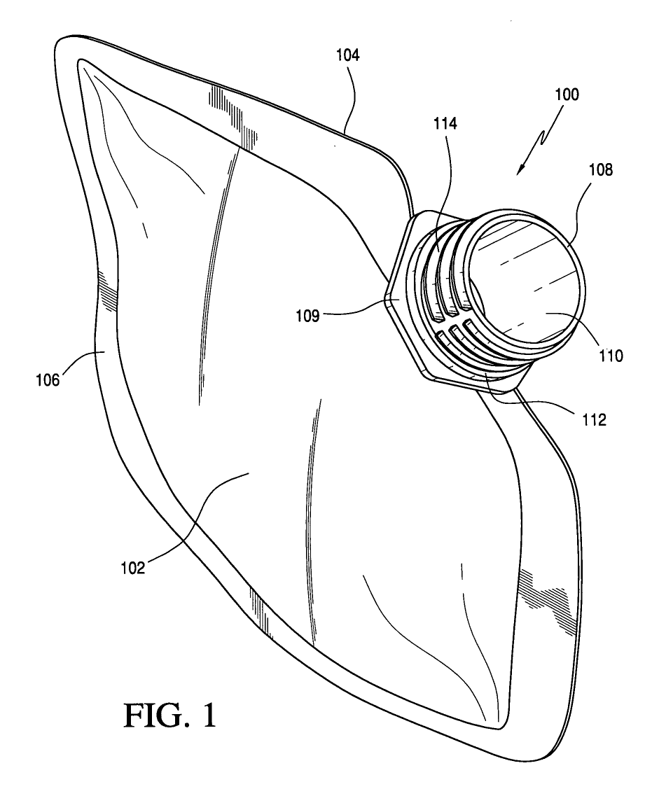

Referring now to the drawings, and more particularly to FIGS. 1-4 thereof, a new and improved liquid paint reservoir, constructed in accordance with the principles and teachings of the present invention, is disclosed and is generally indicated by the reference character 100. The liquid paint reservoir 100 may comprise, for example, a suitable container, bag, package, pouch, sack, or the like, and is preferably fabricated from a suitable flexible and impervious material, such as, for example, a suitable metal foil or a suitable thermoplastic material, such as, for example, polyethylene film so as to permit the liquid paint reservoir 100 to be disposed in a substantially flattened or collapsed state when not being used. In this manner, each liquid paint reservoir 100 will require a minimum amount of shelf storage space, or alternatively, when discarded, will require a minimum amount of trash disposal space. More particularly with respect to the actual structure of the liquid paint reservoir 100, the liquid paint reservoir 100, in the form of, for example, the aforenoted container, bag, package, pouch, sack, or the like, is fabricated from two sheets 102,104 of the aforenoted material, and the two sheets 102,104 of the aforenoted material are sealed together along a peripheral edge portion 106, except for an open region thereof, leading into the interior of the liquid paint reservoir 100, which is adapted to be sealed around an internal end portion of the hollow adaptor member 108 which also comprises a flange portion 109 which has a hexagonal configuration, although, of course, the flange portion 109 may have other geometrical configurations.

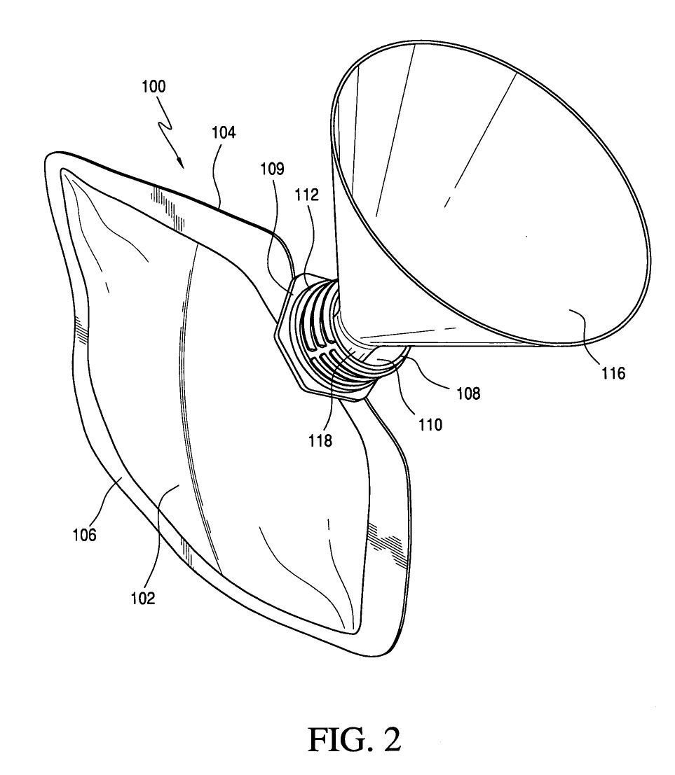

In this manner, the internal end portion of the hollow adaptor member 108 is fluidically connected to the interior of the liquid paint reservoir 100 while the external end portion of the hollow adaptor member 108 is open so as to define a mouth portion 110 by means of which the liquid paint reservoir 100 may be filled with a supply of paint, and, in turn, by means of which the paint, disposed internally within the liquid paint reservoir 100, may be withdrawn from the liquid paint reservoir 100 during a paint spraying operation. The portion of the adaptor member 108 which extends between the internal and external end portions of the adaptor member 108 defines a neck portion 112 which is externally threaded as at 114 for a purpose to be disclosed shortly hereinafter, although as will also become apparent, the same could alternatively be internally threaded. As can best be appreciated from FIG. 2, a supply of paint may be conducted into the liquid paint reservoir 100, so as to fill the liquid paint reservoir 100 with a supply of liquid paint, by means of, for example, a funnel 116 wherein the lower end or tubular portion 118 is inserted into the open mouth portion 110 of the adaptor member 108.

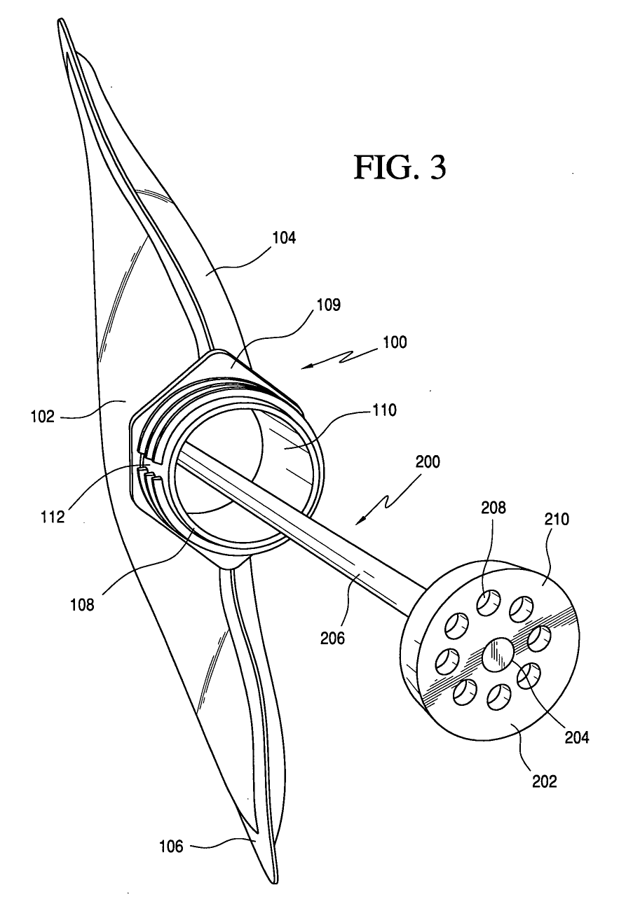

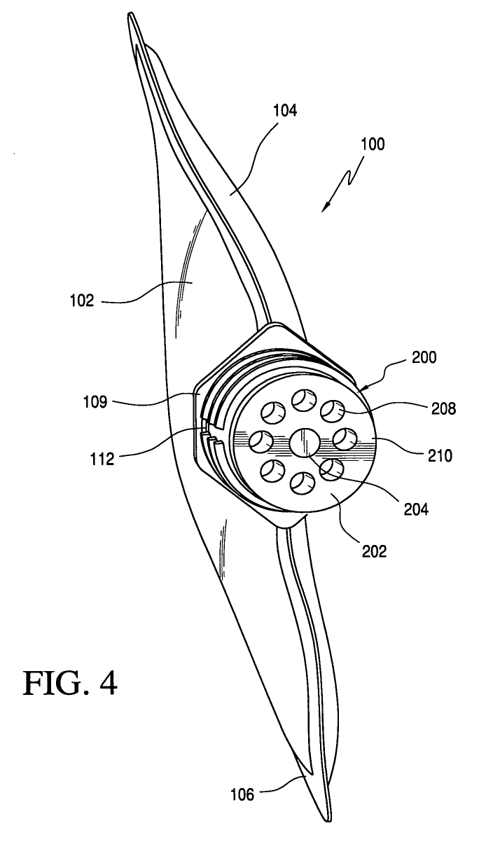

Once the liquid paint reservoir 100 has been filled with paint, a support structure is adapted to be disposed internally within the liquid paint reservoir 100 such that when the liquid paint reservoir 100 is fixedly mounted upon, for example, a paint spray gun, as will be disclosed hereinafter, the liquid paint reservoir 100 will effectively be retained in its substantially upright position above the paint spray gun, and within a substantially vertically oriented plane, such that the liquid paint reservoir will not effectively flop or fold over upon itself, despite, for example, the horizontally or vertically oriented reciprocal or directionally reversible movements normally imparted to the paint spray gun during the performance of a paint spraying operation. More particularly, as can best be appreciated from FIGS. 3 and 4, a first embodiment of a new and improved support structure, as constructed in accordance with the principles and teachings of the present invention, is disclosed and is generally indicated by the reference character 200. The first embodiment support structure 200 is seen to comprise a circular disk-type head member 202, and the axially central portion of the disk-type head member 202 is provided with a central aperture 204 within which an axially outwardly oriented end portion of an axially extending stem member 206 is adapted to be fixedly attached while an axially inward portion of the axially extending stem member 206 is adapted to be disposed internally within the liquid paint reservoir 100 when in fact the axially extending stem member 206 is fixedly attached to the disk-type head member 202 and when the support structure 200 is mounted upon the liquid paint reservoir 100.

The axially extending stem member 206 and the disk-type head member 202 may be fabricated from a suitable thermoplastic material, such as, for example, high-density polyethylene (HDPE), and the disk-type head member 202 is adapted to be secured within an internal peripheral portion of the adaptor member 108, within the vicinity of the open mouth portion 110 of the adaptor member 108, by means of, for example, any suitable fitting, such as, for example, a snap-fit, press-fit, friction fit, or other similar structure. The support structure 200 is disclosed at its installed position within the adaptor member 108 within FIG. 4, however, it is to be noted that prior to the support structure 200 being disposed at its installed position, the internal end portion of the stem member 206 may be used to stir the paint disposed within the liquid paint reservoir 100. It is also noted, as can best be appreciated from both FIGS. 3 and 4, that the disk-type head member 202 is provided with a circular array of through-bores or apertures 208, which are located at radial positions between the central aperture 204 and the outer peripheral surface portion 210 of the disk-type head member 202, and in this manner, when the support structure 200 is in fact disposed at its installed position within the liquid paint reservoir 100, the liquid paint, disposed internally within the liquid paint reservoir 100, can nevertheless be withdrawn from the liquid paint reservoir 100, through means of the apertures 208, during the performance of a paint spraying operation.

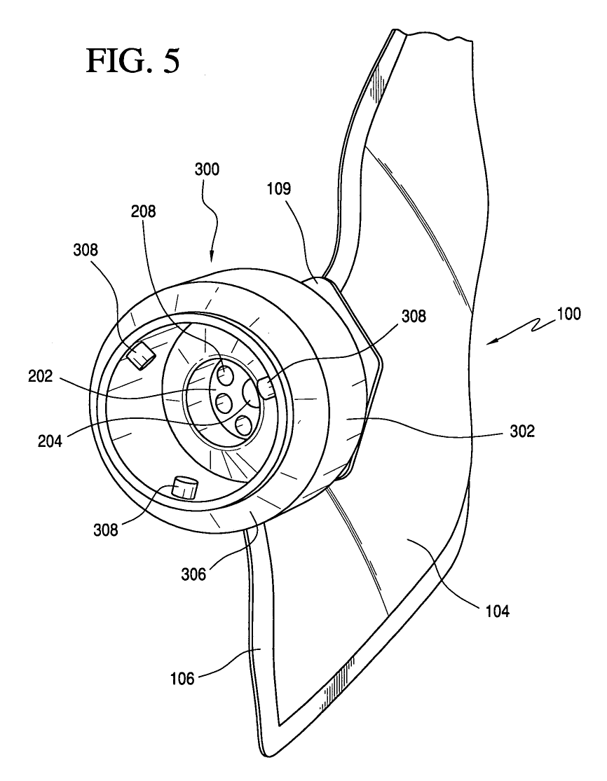

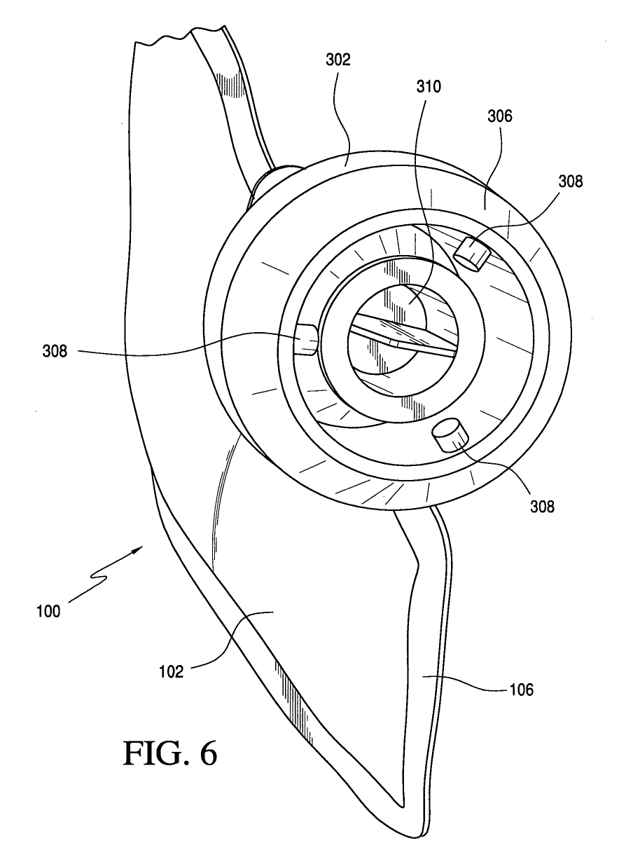

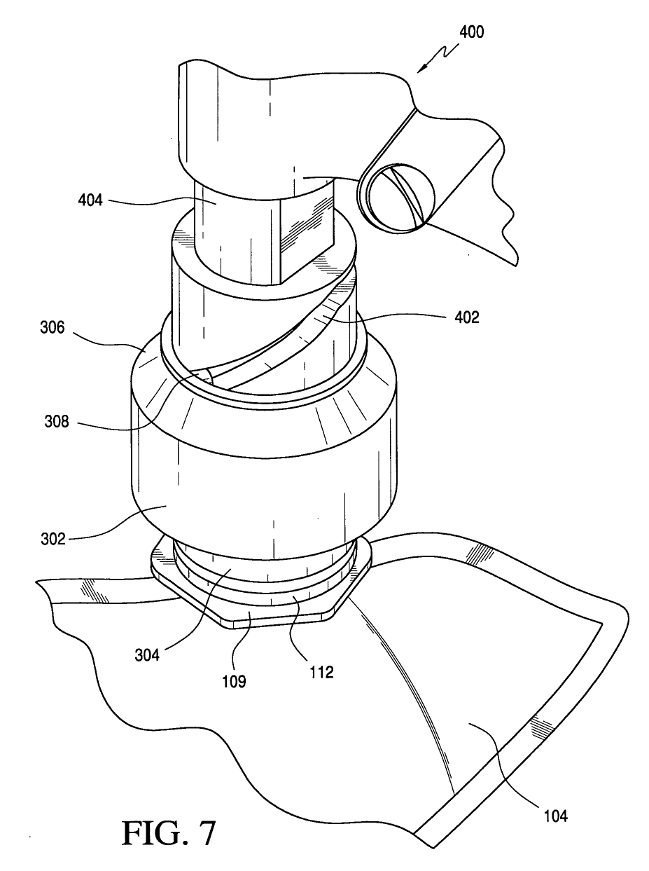

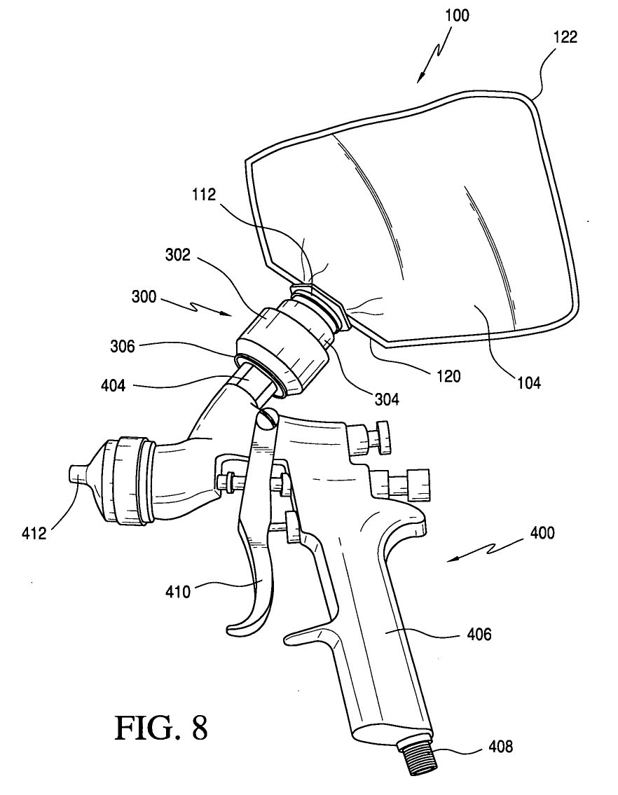

Continuing further, and with reference being made to FIGS. 5-8, after the new and improved support structure 200 has been assembled within the new and improved liquid paint reservoir 100 as illustrated, for example, within FIG. 4, the assembly comprising the liquid paint reservoir 100 and the support structure 200 is ready to be mounted upon a paint spray gun. In order to accomplish this, a coupling member, generally indicated by the reference character 300, is adapted to be mounted upon the adaptor member 108 of the liquid paint reservoir 100. More particularly, it is seen that the coupling member 300 has a central body portion 302 and an internally threaded upper end portion 304, as considered from the viewpoint of its normal disposition when the liquid paint reservoir 100 is mounted upon a paint spray gun, which is generally indicated by the reference character 400 as illustrated within FIG. 8, wherein the internally threaded upper end portion is adapted to be threadedly engaged upon the externally threaded neck portion 112 of the adaptor member 308. As was noted hereinbefore, the neck portion 112 could alternatively be internally threaded whereby the upper end portion 304 of the coupling member 300 would be externally threaded so as to nevertheless define a threaded connection between such component parts. In addition, as can best be appreciated from FIGS. 5 and 6, it is seen that the opposite or lower end portion 306 of the coupling member 300 is provided with, for example, three equiangularly spaced radially inwardly projecting lugs 308 which are adapted to be respectively mated with a corresponding number of spiral grooves 402, in, for example, a bayonet-type manner, wherein the spiral grooves 402 are formed within a mounting arm 404 which is mounted upon an upper end portion of the paint spray gun 400 as can best be appreciated from FIGS. 7 and 8.

It is of course to be appreciated that when the liquid paint reservoir 100 is to actually be mounted upon the paint spray gun 400, the liquid paint reservoir 100 and the paint spray gun 400 are effectively disposed in inverted positions, as illustrated within FIG. 7, with respect to their normal positions, as illustrated within FIG. 8, during a paint spraying operation, so as to effectuate the mounting of the liquid paint reservoir 100 upon the paint spray gun 400 without encountering any inadvertent or accidental spillage or discharge of the liquid paint contents disposed within the liquid paint reservoir 100. As can also be readily appreciated from FIG. 8, the paint spray gun 400 also conventionally comprises handle structure 406 by means of which the paint spray gun 400 can of course be grasped and held by means of operator personnel, a connector 408, located at the lower end portion of the handle structure 406, for providing a mated connection to a source of compressed air, a trigger mechanism 410 for controlling the paint spraying operation, and an output spray nozzle assembly 412 for discharging the atomized spray paint onto the substrate being painted. It is also noted, with reference being made to FIG. 6, that if the liquid paint reservoir 100 is desired or needed to be shaken so as to, for example, better homogenize the paint composition disposed within the liquid paint reservoir 100, a plug 310 can effectively be snap-fitted, press-fitted, friction-fitted, or otherwise similarly secured into the central portion of the coupling member 300 so as to close off or block the apertures 208 defined within the head portion 202 of the support member 200 so as to effectively prevent any inadvertent or accidental spillage or discharge of the liquid paint contents disposed within the liquid paint reservoir 100. The plug 310 may likewise be installed when the liquid paint reservoir 100 is to be stored.

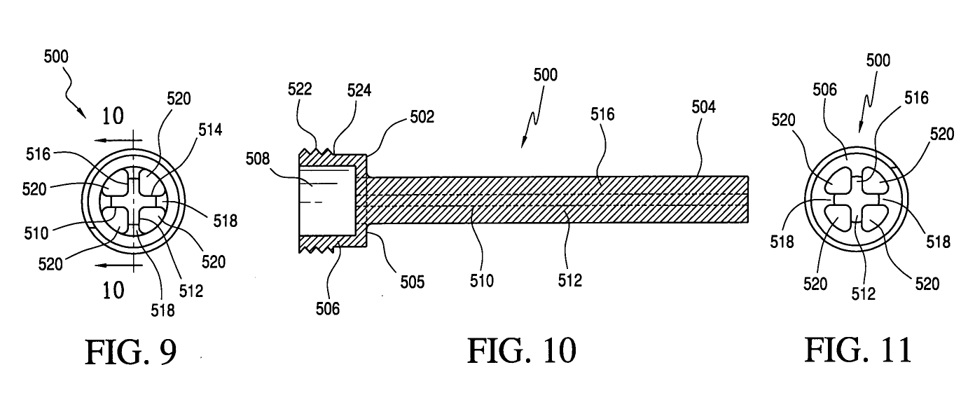

Referring now to FIGS. 9-11, a second embodiment of a new and improved support structure for disposition internally within the liquid paint reservoir 100, and as constructed in accordance with the principles and teachings of the present invention, is disclosed and is generally indicated by the reference character 500. More particularly, it is seen that the second embodiment support structure 500 comprises a head portion 502 and a stem portion 504 wherein the head portion 502 and the stem portion 504 are integrally connected together, as at a neck portion 505, as a result of being fabricated as a single piece, such as, for example, by means of a suitable injection molding process. The support structure 500 may be fabricated from a suitable thermoplastic material, such as, for example, high density polyethylene (HDPE), and it is seen that the head portion 502 comprises a hollow or tubular member 506 having a circular cross-sectional configuration and defining an internal recess or pocket 508, while the stem portion 504 has an X-shaped or cross-shaped cross-sectional configuration which is effectively formed by means of four axially extending rib members 510,-512,514,516. Each one of the axially extending rib members 510,512,514,516 is respectively integrally connected to the head portion 502 by means of a plurality of transition sections 518, and, accordingly, four equiangularly spaced apertures 520 are effectively formed within the support structure 500 so as to permit a supply of liquid paint to be introduced into the liquid paint reservoir 100, after the support structure 500 has been fixedly mounted upon the liquid paint reservoir 100 in a sealed manner similar to the mounting and sealing of the first embodiment adaptor member 108 with respect to the liquid paint reservoir 100, as well as to permit the supply of liquid paint, disposed within the liquid paint reservoir 100, to be withdrawn therefrom during a paint spraying operation.

As can best be appreciated from FIG. 10, the axially outer or lower external annular surface portion of the head portion 502 of the support structure 500, as considered from the point of view of when the liquid paint reservoir 100 is mounted upon the spray gun 400 as illustrated within FIG. 8, is provided with threads 522 so as to permit the internally threaded end portion 304 of the coupling member 300 to be threadedly mated therewith. It is also to be appreciated that the two sheets 102,104 of the liquid paint reservoir 100 will effectively be sealed around a substantially axially located mid-section of the external surface portion of the head portion 502 of the support structure 500, as at 524, such that the threaded portion 522 of the head portion 502 of the support structure 500 will be disposed externally of the liquid paint reservoir 100, in a manner similar to that of the adaptor member 108, while the remainder of the head portion 502, and the stem portion 504 of the support structure 500, will be disposed internally within the liquid paint reservoir 100. Accordingly, when the liquid paint reservoir 100 is to be filled with a supply of liquid paint, the lower end tubular portion 118 of the funnel member 116 is inserted into the recessed pocket portion 508 of the head portion 502 of the support structure 500 and liquid paint can flow through the funnel member 116 and into the liquid paint reservoir 100 through means of the apertures 520 defined within the support structure 500. As can therefore be readily appreciated, the primary structural difference between the support structure 500 and the support structure 200 resides in the fact that in connection with the support structure 200, it can be separated, removed, or even be inadvertently dislodged from the adaptor member 108 and the liquid paint reservoir 100, whereas since the support structure 500 comprises the head portion 502 and the integrally attached stem portion 504, then when the head portion 502, which is effectively or functionally the same as the adaptor member 108, is in fact mated with and sealed to the liquid paint reservoir 100, the support structure 500 cannot be readily separated, removed, or become dislodged from the liquid paint reservoir 100.

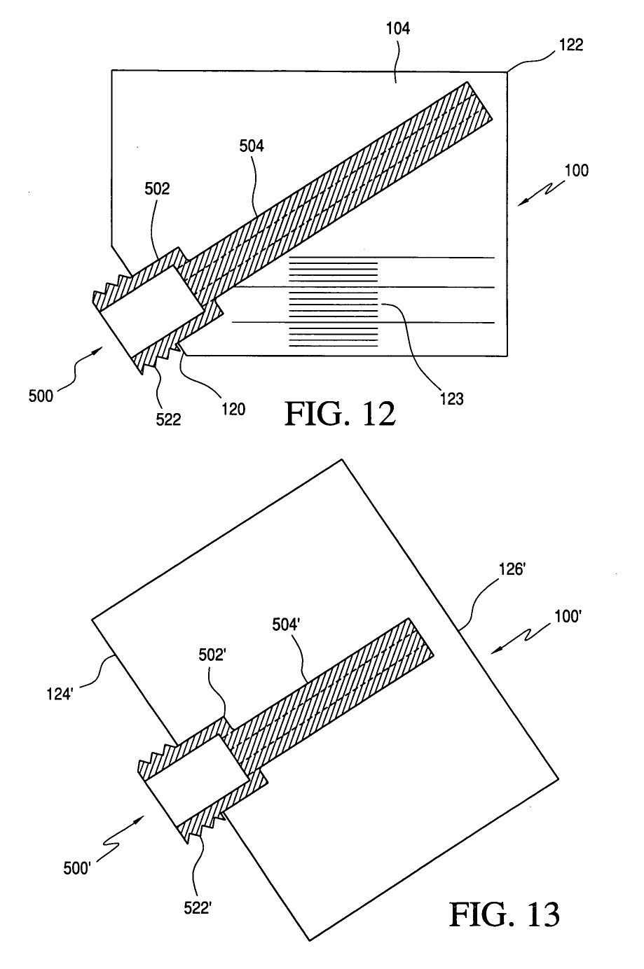

With reference lastly being made to FIGS. 12 and 13, the actual disposition of, for example, the new and improved second embodiment support structure 500, as constructed in accordance with the principles and teachings of the present invention, and as disposed internally within the liquid paint reservoir 100, is disclosed, although it is to be noted that the first embodiment support structure 200 is adapted to be disposed internally within the liquid paint reservoir 100 in substantially the same manner. More particularly, when, for example, the liquid paint reservoir 100 has a substantially rectangular or square cross-sectional configuration, and when the liquid paint fill or discharge opening is effectively provided upon or within a first corner region 120 of the liquid paint reservoir 100, as can best be appreciated from FIGS. 8 and 12, the stem portion 504 of the internal support structure 500 will extend axially toward a second opposite corner region 122 of the liquid paint reservoir 100. In this manner, when the liquid paint reservoir 100 is mounted in its upright position upon the upper end portion of the paint spray gun 400, as illustrated within FIG. 8, the internal support structure 500 will effectively serve to maintain the liquid paint reservoir 100 within its upright disposition, and within the same plane as that of the paint spray gun 400, despite the typical horizontal or vertical reciprocal or directionally reversible movements of the paint spray gun 400 inherently or normally performed during a paint spraying operation.

Accordingly, such internal support structure 500 will effectively prevent the liquid paint reservoir 100 from flopping or folding over upon itself whereby such flopping or folding over of the liquid paint reservoir 100 upon itself could interfere with the proper dispensing of the paint, such flopping or folding over of the liquid paint reservoir 100 could entrap a portion of the paint supply within the liquid paint reservoir 100 which may then be inadvertently discarded and wasted, or such flopping or folding over of the liquid paint reservoir 100 could adversely alter the desired control of the paint spray gun by the operator personnel so as to, in turn, adversely affect the preciseness and finish appearance of the paint being sprayed onto a particular substrate. It is also noted that while it is illustrated within FIG. 12 that the stem portion 504 of the internal support structure 500 effectively extends across substantially the entire diagonal length or dimension of the liquid paint reservoir 100, this is not necessarily the case. Depending, for example, upon the particular fabrication of the liquid paint reservoir 100, such as, for example, depending upon the particular materials from which the liquid paint reservoir sheets 102,104 are fabricated, the thickness dimensions of such liquid paint reservoir sheets 102,104, and the like, the liquid paint reservoir 100 will exhibit an inherent amount of flexibility and the axial extent of the stem portion 504 of the internal support structure 500 will vary accordingly.

For example, if the flexibility of the liquid paint reservoir 100 is relatively large, then the axial or diagonal extent or length of the stem portion 504 of the internal support structure 500 will need to be relatively large in order to effectively provide the flexible liquid paint reservoir 100 with an increased amount or degree of support. To the contrary, if the flexibility of the liquid paint reservoir 100 is relatively small, then the axial or diagonal extent or length of the stem portion 504 of the internal support structure 500 may be relatively short in that the flexible liquid paint reservoir 100 only requires a smaller amount or degree of internal support. It is lastly noted in connection with the liquid paint reservoir 100 that in lieu of the sheets 102,104 thereof being fabricated from a particular material which is opaque, one or both of the sheets 102,104 may be fabricated from a suitable material which is effectively transparent. Accordingly, suitable, substantially horizontally oriented indicia 123 may be provided upon, for example, sheet 104 of the liquid paint reservoir 100 in order to provide operator personnel with an indication of how much liquid paint is actually disposed within the liquid paint reservoir 100. Such indicia can be used so as to fill the liquid paint reservoir 100 with a desired amount of paint, or to facilitate operator personnel in mixing different paint ratios within the liquid paint reservoir.

As disclosed within FIG. 13, it can readily be appreciated that in lieu of the liquid paint fill or discharge opening being effectively provided upon or within a first corner region 120 of the liquid paint reservoir 100, as was illustrated within FIG. 12, the liquid paint fill or discharge opening may alternatively be provided upon or within a first side edge portion 124′ of the liquid paint reservoir 100′ whereby the stem portion 504′ of the internal support structure 500′ will effectively extend across one of the major or minor dimensions of the liquid paint reservoir 100′ so as to terminate within the vicinity of a second opposite side edge portion 126′ of the liquid paint reservoir 100′. As was discussed in connection with the disposition of the internal support structure 500 within the liquid paint reservoir 100 when the adaptor or head portion 502 of the support structure 500 is mounted upon a corner region of the liquid paint reservoir 100, as illustrated within FIG. 12, the actual length or axial extent of the stem portion 504′ of the internal support structure 500′, as disposed within the liquid paint reservoir 100′, may likewise vary depending upon or as a function of the fabrication parameters of the sheets 102,104 comprising the liquid paint reservoir 100′. In addition, the liquid paint reservoir 100′ may likewise be fabricated from transparent materials whereby indicia, not shown, but similar to indicia 123, may likewise be provided upon the liquid paint reservoir 100′.

Thus, it may be seen that in accordance with the principles and teachings of the present invention, there has been provided a new and improved disposable liquid paint reservoir which is adapted for use in connection with a paint spray gun, and wherein a substantially rigid support member is operatively connected to the adaptor member such that the support member extends internally within the liquid paint reservoir, and along a substantial portion of a major axis or dimension of the liquid paint reservoir, as defined from the adaptor member to an opposite end portion of the liquid paint reservoir, so as to effectively prevent the liquid paint reservoir from flopping or folding over upon itself during a paint spraying operation which could operatively interfere with the proper dispensing of the paint, which could entrap a portion of the paint supply within the liquid paint reservoir which may then be inadvertently discarded and wasted, or which could adversely alter the desired control of the paint spray gun by the operator personnel so as to, in turn, adversely affect the preciseness and finish appearance of the paint being sprayed onto a particular substrate.

Obviously, many variations and modifications of the present invention are possible in light of the above teachings. For example, while the liquid paint reservoir has been disclosed as having a substantially square or rectangular cross-sectional configuration, the liquid paint reservoir may of course have other cross-sectional configurations. Accordingly, when the internal support member is used in conjunction with such liquid paint reservoirs having such other cross-sectional configurations, the internal support member will extend internally within the particular liquid paint reservoir in a manner similar to that disclosed in connection with the substantially square or rectangularly configured liquid paint reservoirs as disclosed, for example, within FIGS. 12 and 13. For example, if the liquid paint reservoir has a circular cross-sectional configuration, then the internal support member would extend in a substantially radially inward or diametrical manner across the internal portion of the liquid paint reservoir so as to provide the same with the necessary rigidity and support. In a similar manner, the internal support member need not necessarily be connected to the adaptor or head portion but may otherwise be disposed internally within the liquid paint reservoir so as to nevertheless provide the requisite support thereto. It is therefore to be understood that within the scope of the appended claims, the present invention may be practiced otherwise than as specifically described herein.

What is claimed as new and desired to be protected by Letters Patent of the United States of America, is:

1. A disposable liquid reservoir for use with a liquid spray gun, comprising:
a container fabricated from a flexible material, impervious to liquid, for containing a supply of liquid, wherein said container, fabricated from said flexible material, can be rendered substantially flat when not filled with a supply of liquid;
means defining an opening within said container through which a supply of liquid can be conducted into the interior of said liquid container and by which the supply of liquid, disposed within said liquid container, can be withdrawn from said liquid container during a liquid spraying operation performed by a liquid spray gun; and
support structure extending internally within said liquid container, for effectively providing said flexible liquid container with a sufficient degree of rigidity such that said liquid container will not fold over upon itself despite reciprocal and directionally reversible movements of the liquid spray gun during a liquid spraying operation.

2. The disposable liquid reservoir as set forth in claim 1, wherein:
said liquid container is fabricated from a material selected from the group comprising a metal foil and a thermoplastic material.

3. The disposable liquid reservoir as set forth in claim 1, wherein said support structure comprises:
a head portion fixedly disposed within and sealed to said means defining said opening within said container; and
a stem portion fixedly connected to said head portion and extending internally within said liquid container so as to effectively provide said flexible liquid container with a sufficient degree of rigidity such that said liquid container will not fold over upon itself despite reciprocal and directionally reversible movements of the liquid spray gun during a liquid spraying operation.

4. The disposable liquid reservoir as set forth in claim 3, wherein:
said stem portion is integrally formed with said head portion as a single-piece entity.

5. The disposable liquid reservoir as set forth in claim 3, wherein:
a section of said head projects outwardly from said container so as to facilitate the operative mounting of said disposable liquid reservoir upon a liquid spray gun.

6. The disposable liquid reservoir as set forth in claim 5, wherein:
said section of said head that projects outwardly from said container is threaded so as to provide a threaded connection to the liquid spray gun.

7. The disposable liquid reservoir as set forth in claim 3, wherein:
said head portion comprises a tubular member;
recessed pocket means is defined within said tubular head portion for receiving a liquid supply member; and
a plurality of apertures are formed within said support structure where said stem portion is fixedly connected to said head portion so as to permit liquid from the liquid supply member to flow into the interior of said container in order to fill said container with liquid, and to permit liquid, disposed within said container, to flow outwardly from said container during a liquid spraying operation.

8. The disposable liquid reservoir as set forth in claim 7, wherein:
said stem portion has a substantially cross-shaped cross-sectional configuration.

9. The disposable liquid reservoir as set forth in claim 8, wherein:
said stem portion, having said cross-shaped cross-sectional configuration, comprises four rib members wherein end portions of said four rib members are fixedly connected at predetermined locations to said head portion of said support structure so as to respectively define said plurality of apertures between said locations at which said four rib members are connected to said head portion.

10. The disposable liquid reservoir as set forth in claim 1, wherein said support structure comprises:
adaptor means fixedly disposed within and sealed to said means defining said opening within said liquid container for permitting said liquid container to be filled with liquid and for permitting said liquid container to be fixedly mounted upon a liquid spray gun;
a head portion fixedly secured within said adaptor means and having a plurality of apertures defined therein for permitting liquid, disposed within said liquid container, to flow outwardly from said liquid container during a liquid spraying operation; and
a stem portion fixedly connected to said head portion and extending internally within said liquid container so as to effectively provide said flexible liquid container with a sufficient degree of rigidity such that said liquid container will not fold over upon itself despite reciprocal and directionally reversible movements of the liquid spray gun during a liquid spraying operation.

11. The disposable liquid reservoir as set forth in claim 10, wherein:
said stem portion comprises a means for stirring the liquid disposed within said liquid container.

12. The disposable liquid reservoir as set forth in claim 1, wherein:
at least part of said liquid container is fabricated from a transparent material; and
indicia means is provided upon said liquid container so as to indicate to operator personnel the volume of liquid disposed within said liquid container.

13. In combination, a liquid spray gun and a disposable liquid reservoir adapted to be attached to the liquid spray gun for use with the liquid spray gun during the performance of a liquid spraying operation, comprising:
a liquid spray gun;
a disposable liquid reservoir; and
coupling means for fixedly mounting said disposable liquid reservoir upon said liquid spray gun;
said disposable liquid reservoir comprising a container fabricated from a flexible material, impervious to liquid, for containing a supply of liquid, wherein said container, fabricated from said flexible material, can be rendered substantially flat when not filled with a supply of liquid; means defining an opening within said container through which a supply of liquid can be conducted into the interior of said liquid container so as to fill said liquid container with liquid, and by which the supply of liquid, disposed within said liquid container, can be withdrawn from said liquid container during a liquid spraying operation performed by said liquid spray gun; and support structure, operatively connected to said means defining said opening within said liquid container and extending internally within said liquid container, for effectively providing said flexible liquid container with a sufficient degree of rigidity such that said liquid container will not fold over upon itself despite reciprocal and directionally reversible movements of said liquid spray gun during a liquid spraying operation.

14. The combination as set forth in claim 13, wherein:
said liquid container is fabricated from a material selected from the group comprising a metal foil and a thermoplastic material.

15. The combination as set forth in claim 13, wherein said support structure comprises:
a head portion fixedly disposed within and sealed to said means defining said opening within said container; and
a stem portion fixedly connected to said head portion and extending internally within said liquid container so as to effectively provide said flexible liquid container with a sufficient degree of rigidity such that said liquid container will not fold over upon itself despite reciprocal and directionally reversible movements of said liquid spray gun during a liquid spraying operation.

16. The combination as set forth in claim 15, wherein:
said stem portion is integrally formed with said head portion as a single-piece entity.

17. The combination as set forth in claim 15, wherein:
a section of said head projects outwardly from said container so as to facilitate the operative mounting of said disposable liquid reservoir upon said liquid spray gun.

18. The combination as set forth in claim 17, wherein:
said section of said head that projects outwardly from said container is threaded so as to provide a threaded connection with said coupling means.

19. The combination as set forth in claim 15, wherein:
said head portion comprises a tubular member;
recessed pocket means is defined within said tubular head portion for receiving a liquid supply member; and
a plurality of apertures are formed within said support structure where said stem portion is fixedly connected to said head portion so as to permit liquid from the liquid supply member to flow into the interior of said liquid container in order to fill said liquid container with liquid, and to permit liquid, disposed within said liquid container, to flow outwardly from said liquid container during a liquid spraying operation.

20. The combination as set forth in claim 19, wherein:
said stem portion has a substantially cross-shaped cross-sectional configuration.

21. The combination as set forth in claim 20, wherein:
said stem portion, having said cross-shaped cross-sectional configuration, comprises four rib members wherein end portions of said four rib members are fixedly connected at predetermined locations to said head portion of said support structure so as to respectively define said plurality of apertures between said locations at which said four rib members are connected to said head portion.

22. The combination as set forth in claim 13, wherein said support structure comprises:
adaptor means fixedly disposed within and sealed to said means defining said opening within said liquid container for permitting said liquid container to be filled with liquid and for permitting said liquid container to be fixedly mounted upon a liquid spray gun;
a head portion fixedly secured within said adaptor means and having a plurality of apertures defined therein for permitting paint, disposed within said liquid container, to flow outwardly from said liquid container during a liquid spraying operation; and
a stem portion fixedly connected to said head portion and extending internally within said liquid container so as to effectively provide said flexible liquid container with a sufficient degree of rigidity such that said liquid container will not fold over upon itself despite reciprocal and directionally reversible movements of said liquid spray gun during a liquid spraying operation.

23. The combination as set forth in claim 22, wherein:
said stem portion comprises a means for stirring the liquid disposed within said liquid container.

24. The combination as set forth in claim 12, wherein:
at least part of said liquid container is fabricated from a transparent material; and
indicia means is provided upon said liquid container so as to indicate to operator personnel the volume of liquid disposed within said liquid container.
